(19) United States
(12) Patent Application Publication
(10) Pub. No.: US 2005/0281559 A1
(43) Pub. Date: Dec. 22, 2005

(54) Adjustable coverage infrared transmission system

(76) Inventor: Francis C. Van Asten, Bloomington, MN (US)

Correspondence Address: ALTERA LAW GROUP, LLC, 6500 CITY WEST PARKWAY, SUITE 100, MINNEAPOLIS, MN, 55344-7704, US

(21) Appl. No.: 11/214,496

(22) Filed: Aug. 29, 2005

Related U.S. Application Data
(63) Continuation of application No. 10/068,191, filed on Feb. 5, 2002, now abandoned.

(51) Int. Cl. H04B 10/00

(52) U.S. Cl. 398/140

(57) ABSTRACT

The present invention provides for a method and apparatus for an infrared transmission system utilizing a circuit board equipped with LEDs having bendable lead wires to transmit an infrared carrier signal. An infrared emitter converts an input signal into a modulated wave for optical transmission via the LEDs. The LEDs are connected to the circuit board with the lead wires bent to aim the LEDs as desired. The bendable LEDs provide near half sperical range of adjustment and the aiming of the LEDs on a board may be adjusted on site for a specific coverage configuration. With respect to the mounting platform, each LED is adjustably pointed or directed to a principal angular direction. This principal angular direction can be shared with other LEDs or unique to that specific LED. By changing the principal angular direction of the LEDs, the shape and size of the infrared transmission coverage area can be selectively adjusted. This provides for flexibility and maximization of the coverage area. At least one infrared receiving unit is within the transmission coverage area for receiving the infrared signal and converting the signal for audio media output.

### FIELD OF THE INVENTION

The present invention relates generally to the field of infrared transmission. More specifically, this invention relates to the infrared transmission of analog and or digital stream within an enclosed environment through the use of a plurality of individually adjustably directed light emitting diodes.

### BACKGROUND OF THE INVENTION

The use of wireless infrared technology in transmitting information is common throughout the industry. The technology has been applied successfully in applications including language translation, assisted listening for persons with hearing disabilities and as a method of providing information for self-guided walking tours.

Such wireless transmission of information is generally accomplished through the use of light emitting diodes (LEDs). A transmitter or emitter is used to transform an input into a modulated wave. Using an LED, the wave is converted into light radiation and projected from the emitter to a receiving device.

Conventional use of light radiation in these wireless transmission systems suffers from a number of disadvantages. First, infrared carrier signals share some of the same traits as visible light. For example, infrared signals cannot pass through opaque objects which restricts the coverage area. Finally, infrared carrier signals require an unbroken path between emitter and receiver to facilitate signal transmission. Though line of sight communication is most desirable, infrared signals can reflect off of reflective surfaces and objects. However, if the line of sight or reflected infrared signal is interrupted, the receiving device will fail to receive the light radiation of the LED and the user will no longer hear the audio stream.

As wireless infrared technology has become an accepted method of transmitting signals, the need for more reliable communication between emitter and receiver has increased. In order to increase the reliability of the transmission and reception of wireless infrared signals between emitter and receiver, designs have been employed in an attempt to solve some of the mentioned problems. For instance, some designs provide for multiple infrared signals in an attempt to reduce signal block through the introduction of signal redundancy.

One method of supplying this level of redundancy has been to provide for multiple emitters and/or receivers. By using multiple emitters which transmit the same infrared signal, the coverage area is increased. Though a receiver may not be in the line of sight of one emitter, another emitter located elsewhere in the reception area may be able to communicate with the receiver. By providing for multiple receivers, a user can move throughout the reception area and remain in line of sight of the emitter LEDs. Though both methods have been previously employed, both can be quite costly. In addition, the introduction of multiple receivers and/or emitters introduces undesirable complexity into the systems.

Another attempt at increasing the infrared coverage area has been to utilize the multiple LEDs inside the emitter with the LEDs mounted on separate boards or platforms pointing in different directions. An alternative known arrangement is to have LEDs on a single board with the LEDs all pointing in the same direction but with the LEDs having different projection angles. Examples of the above include U.S. Pat. No. 5,596,648 which discloses a 360° array of LEDs, U.S. Pat. No. 5,861,968 which discloses LEDs mounted in revolvable turrets on a PCMCIA card and U.S. Pat. No. 5,903,373 which discloses a series of LEDs mounted at 45° angles to widen the coverage area. The '373 patent does not disclose or suggest providing the 45° angle by bending wire leads.

These designs are problematic since they require undesirably complex and thus more costly emitters. In addition, these designs do not allow for system flexibility with regard to the configuration and needs of a specific location. Nor do these designs allow for a simple factory or on-site adjustment of an assembled LED emitter to optimize the emitter for a specific location. The configuration needs of a building, an auditorium, and even the movement and placement needs of the people within these environments vary greatly. Conventional transmission systems do not allow for flexibility in adjusting to these varying needs.

What is needed is an inexpensive and highly adaptable transmission system for increasing the infrared transmission coverage area within an indoor environment.

### BRIEF SUMMARY OF THE INVENTION

The present invention provides for a method and apparatus for an infrared transmission system utilizing a circuit board equipped with bendable LEDs to transmit an infrared carrier signal. An infrared emitter converts an audio input signal into a modulated wave for optical transmission via the LEDs. The LEDs are connected to the circuit board with the lead wires bent to aim the LEDs as desired. The bendable LEDs provide nearly half sperical range of adjustment and the aiming of the LEDs on a board may be adjusted on site for a specific coverage configuration. With respect to the mounting platform, each LED is adjustably pointed or directed to a principal angular direction. This principal angular direction can be shared with other LEDs or unique to that specific LED. By changing the principal angular direction of the LEDs, the shape and size of the infrared transmission coverage area can be selectively adjusted. This provides for flexibility and maximization of the coverage area At least one infrared receiving unit is within the transmission coverage area for receiving the infrared signal and converting the signal for audio media output.

Preferably, a single emitter unit is used to convert the input signal into an infrared carrier signal. The emitter can be mounted in a variety of configurations to increase the coverage area. Mounting sites include sidewalls and ceilings.

An advantage and feature of the present invention is in its flexibility. The LEDs can be directed in a manner that provides for a myriad of configurations. Environments of varying shapes and sizes can be targeted through the emitter unit's transmission such that substantially all of the area is covered if desired. Similarly, this flexibility makes it possible to avoid over-transmitting—transmitting to areas of the environment where transmissions are not desired or needed.

Another advantage and feature of the present invention is that manufacturing and design costs of the emitter units are significantly reduced. Complex circuit board designs, housing designs, and other methods and apparatus, i.e., lenses or reflectors, for directing the infrared transmission are avoided. Instead, a selectively adjustable angle change to the lead wires of the LED is all that is needed to fine tune, or greatly change, the shape and size of the transmission coverage area.

Another advantage and feature of the invention is that once adjusted, the zone of coverage can be readjusted for a different installation location or readjusted for the physical modification of a particular reception area.

### BRIEF DESCRIPTION OF THE DRAWINGS

FIG. 1 shows an infrared transmission system within an environment according to the present invention.

FIG. 2 is a perspective view of an emitter with an enclosure.

FIG. 3 is a perspective view of a LED array on a platform in accordance with the invention.

FIG. 4 is a front elevational view of the LED platform of FIG. 3.

FIG. 5 is a side elevational view of the LED platform of FIG. 3.

FIG. 6 is a cross-sectional view through a LED circuit board illustrating two LEDs in accordance with the invention bent along their easy bend axis.

FIG. 7 is a cross-sectional view through a LED circuit board illustrating a LED oriented in a position other than in its easy bend axis.

FIG. 8 is an edge view of a preferred embodiment of the present invention showing an edge view of the LEDs and circuit board.

FIG. 9 is a perspective view of a transmission coverage area created according to the present invention.

FIG. 10 is a perspective view of a transmission coverage area created according to the present invention.

FIG. 11 is a perspective view of a transmission coverage area created according to the present invention.

FIG. 12 is a block diagram of an infrared transmission system according to the present invention.

FIG. 13 is a block diagram of an infrared transmission system according to the present invention.

FIG. 14 is an alternative embodiment of a receiving unit according to the present invention.

### DETAILED DESCRIPTION OF THE DRAWINGS

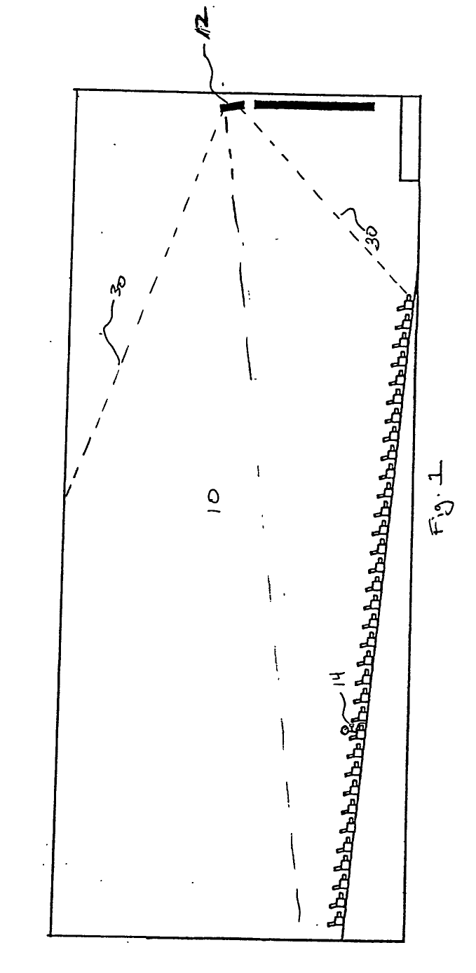

Referring to FIG. 1, a preferred embodiment of the infrared transmission system according to the present invention is shown and is principally comprised of a transmission environment configured as a arena 10, an emitter 12, and at least one receiver 14. The transmission arena may be a closed indoor environment such as an auditorium, a meeting room, conference room, a church, and the like. Outdoor environments may also be suitable for use.

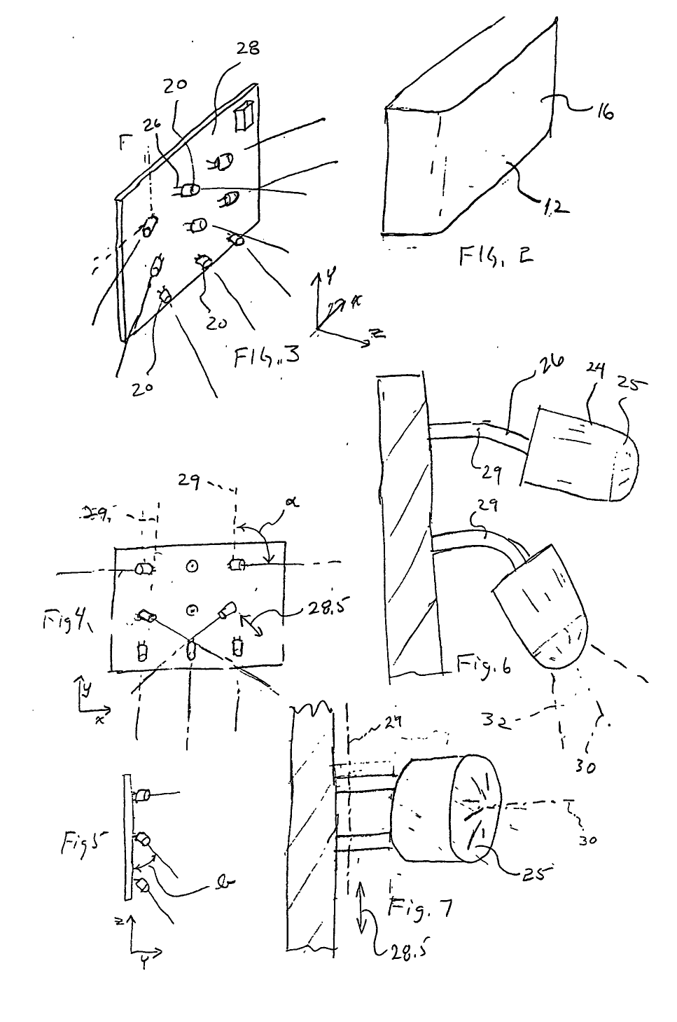

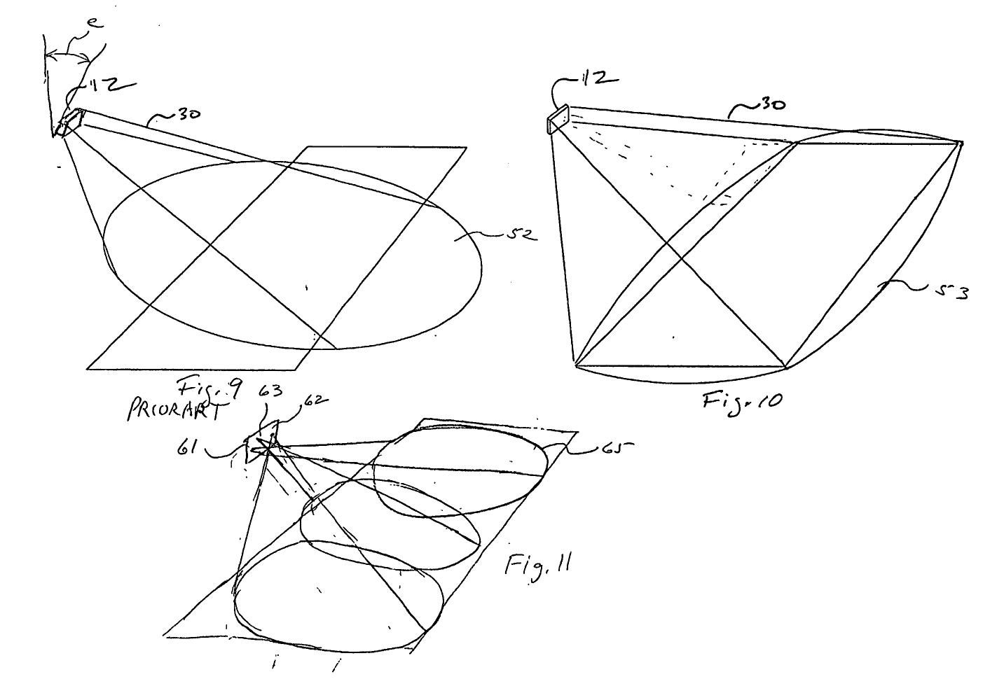

Referring to FIGS. 2-8, details of one embodiment of an emitter 12 are illustrated. The emitter comprises a transparent face 16, a plurality of LEDs 20 connected to an LED mounting board configured as a circuit board 28. Each of the plurality of LEDs 20 is comprised of an infrared light-emitting portion 24 with a lens portion 25 and at least two bendable lead wires 26. Each LED 20 is connectable to an LED platform configured as a circuit board 28 using the bendable lead wires 26. The connecting of the LEDs 20 to the circuit board 28 is preferably achieved with conventional soldering techniques. The lead wires generally extend perpendicularly from the circuit board 28 as best illustrated in FIG. 6. A preferred embodiment would utilize a pair of lead wires 26 for every LED connection, although LEDs with lead wires numbering greater than two may be used.

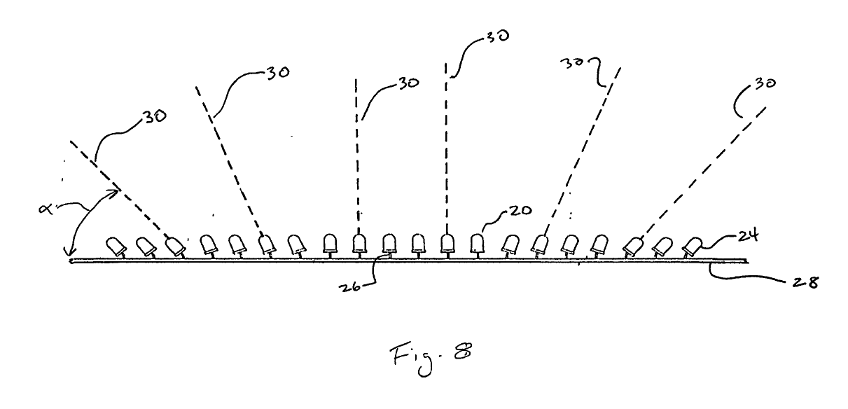

The lead wires of the LEDs define an alignment direction 28.5, as well as an easy bend axis 29 about which the light emitting portion 24 may be easily bent to orient the LED in an angular direction 30. The easy bend axis is defined by the lead wires and generally parallel to the circuit board and the alignment direction. Each LED has a projection region 32, typically cone-shaped, with a central aiming axis 33 centered in the projection region. The angular direction 30 is the angle in which each of the LEDs 20 is pointing in relation to a reference. For example, referring to FIGS. 4 and 5, the angular direction can be identified as an angle “x” in degrees from a vertical coordinate line and an angle “b” from the vertical circuit board. Generally “x” will be 90° from the easy bend axis. This angular direction 30 is the centralized line of the emission path for the infrared media transmission from the light emitting portion 24. Each one of the plurality of LEDs 20 could have a different angular direction, they could all be the same, or there could be groups of LEDs that are assigned specific angular directions differing from other LED groups on a single circuit board 28. This angular direction 30 is directly controlled by the bending of the bendable lead wires 26. For instance, the lead wire of the mentioned LED with an angular direction 30 of 90 degrees would be substantially straight in its connectable relationship between the circuit board 28 and the light emitting portion 24.

The bending of the lead wires 26 can be achieved by numerous bending means 42, and at various times. A suitable bending tool could be used at the manufacturing stage, or at any stage after the LEDs 20 have been selectively connected to the circuit board 28. Such a tool preferably grasps or engages at least one LED, but likely a plurality of LEDs, for example a complete row of LEDs, such that an angular displacement of the tool proportionally bends the lead wire 26 that is connecting the grasped or engaged LED to the circuit board 28. Various embodiments of this tool can have predetermined angular settings such that a displacement will result in a predetermined and substantially accurate angular direction 30. The tool can be equipped with fixed angular displacements such that engagement of the tool will result in a predetermined bend of the lead wire 26, and as a result, a predetermined angular direction 30. Another embodiment of the tool can have a variable angular displacement such that one tool can apply a myriad of bends depending on the particular desired bend. Such a tool could have angle indication means.

Of course, an installer or end user can manually bend, by grasping with her fingers, one or all of the plurality of LEDs and, specifically, the corresponding lead wires 26. This would be optimal in those situations where a specific configuration for the installation environment (i.e., an auditorium) requires an on-site adjustment in the transmission coverage area.

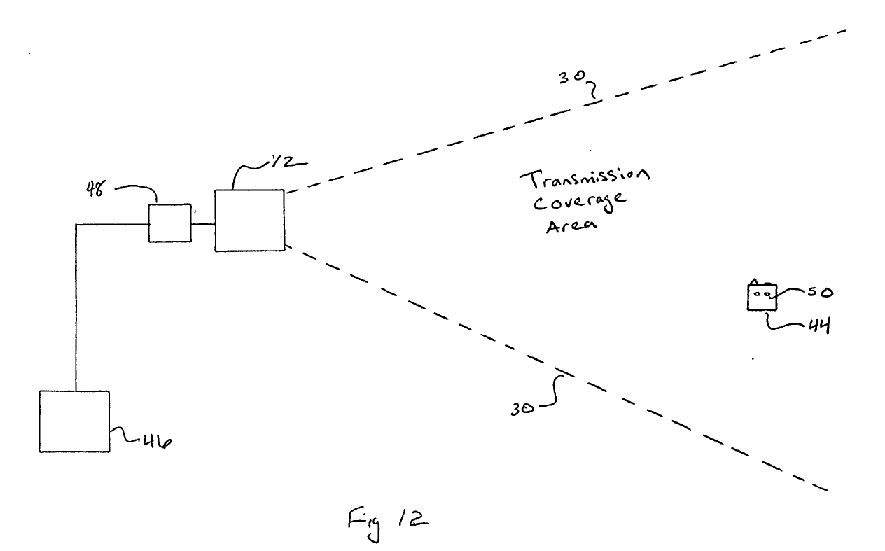

FIGS. 9 through 11 show infrared transmission coverage areas and how a change in the angular directions 30 of the LEDs 20 can change the size and shape of the coverage area to better suit an end user's particular needs. The lead wires 26 can be bent in a manner that defines the shape and size of the transmission coverage area. While an emitter unit 12 may be shipped to an end user with the coverage area shape and size defined by the angular direction 30 of the LEDs 20, the emitter unit 12 may be moved, or the needs of the end user and the overall use of the environment may change such that a new coverage area must be defined. The present invention permits such modifications since bending means can easily adjust or bend the lead wires 26 and thus correspondingly change the coverage area. One method of testing and modifying the coverage area is to place an infrared detection unit in the environment to detect the boundaries of the coverage area. The boundaries can be “mapped” out by observing those areas where an infrared signal is received. The receiving unit 44 can be used to achieve this detection. Alternatively, an infrared detection and/or signal strength meter or device can be used. This infrared boundary detection information can be used by the end user in making changes to the coverage area through the bending of selected LEDs 20. Modification to the transmission coverage area can be accomplished with any of the bending means 42.

Where the angular direction 30 of the LEDs 20 is such that each has a direction of 90 degrees in relation to the circuit board 28 would result in a transmission coverage area 52 substantially equal in size and shape of the projection region. Such is shown in FIG. 9. Where the emitter unit is wall mounted in the conventional arranagement with the LEDs directed perpendicularly from the circuit board, the circuit board will be angled forwarding at an angle to cast the coverage zone on the floor rather than waste i.v. radiation energy above the locations where the receivers will be located. FIG. 10 illustrates a shaped coverage area 53 provided by a single emitter unit 12, rather than tilting the unit or circuit board forward, all of the LEDs in the emitter unit 12 may be pointed downwardly by bending the lead wires such that the zone of coverage does not extend to non use areas.

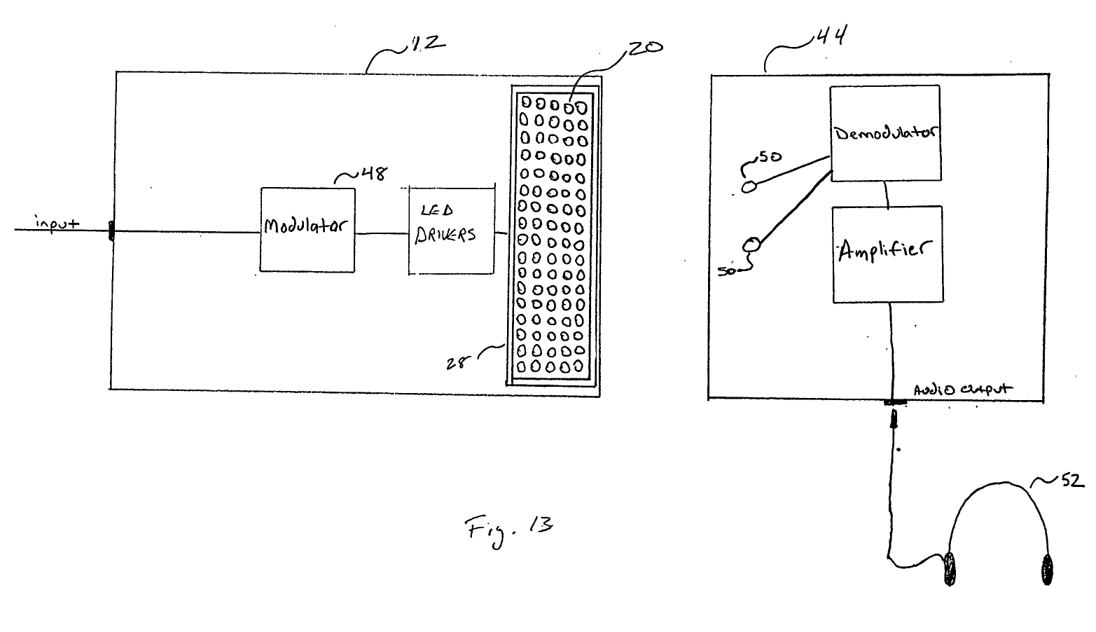

FIG. 11 illustrates how LEDs on the ends may be pointed to the side of the area opposite the side where the LEDs are positioned, this allows the size of the transparent face to be minimized. Generally, the LED on the left side 61 are pointed to the right and downward, the LED on the right side 62 is pointed left and downward and the LED in the middle 63. Is pointed downwardly. Although one row of 3 LEDs is illustrated, multiple rows and columns would be typical. The circular boundaries of the coverage generally indicate the effective region of the LED and typical receiver. Adjustments, drastic and fine, can be made to these angles to selectively define the shape and size of the coverage area.

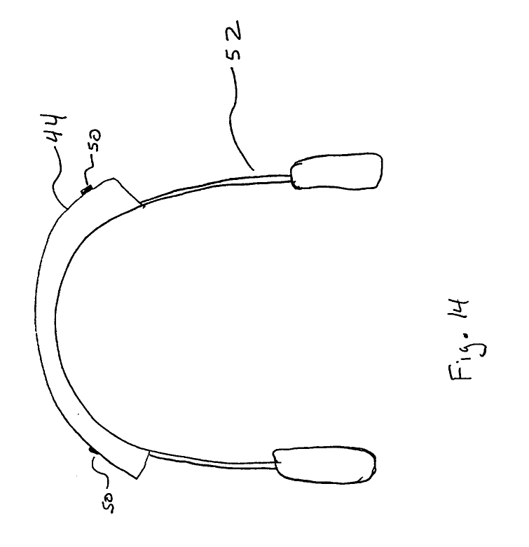

The lead wires 26 within the emitter unit 12 are bent in a manner to define the appropriate desired principal angular directions 30 and the resulting coverage area. The coverage area can be any open or enclosed environment such as a meeting room, auditorium, or similar venues. As an example, in FIG. 12, an audio from a sound system 46 is fed into a modulator 48 where a frequency modulated signal is sent to the emitter unit 12 which converts the signal into light radiation for transmission to at least one receiving unit 44 located somewhere in the defined transmission coverage area. As shown in FIG. 13, the emitter 12 may include the modulator circuitry 48, or as seen in FIG. 12, a separate modulator 48 may be used to feed directly into the emitter 12. The receiving unit 44 is preferably utilized by, and in the possession of, an audience member. In one embodiment the modulated frequency from the modulator 48 to the emitter unit 12 is either a 95 kHz or 250 kHz signal sent via coaxial cable. The light radiation is projected out of the LEDs 20, along the angular directions 30 of each of the LEDs 20, to at least one receiving unit 44 in the coverage area. The at least one receiving unit 44 can be positioned anywhere within the defined coverage area and still receive the light radiation from the emitter unit 12. The receiving unit 44 takes the light radiation media and converts it into audio stream data. This radiation signal from the emitter unit 12 is received by the receiver 44 through at least one radiation receiving sensor or “eye” 50 on at least one of the outer surfaces of the receiver 44. The received signal is converted by the receiver 44 back into an audio signal. Looking at FIG. 13, the receiver 44 generally receives earphone or headphone units 52 which enables the audience member to listen to the converted audio message. In the embodiment shown in FIG. 14, the receiver 44 is encompassed within a headphone unit 52 for easy travel within the coverage area.

An embodiment of this transmission system would enable a human speaker to give a speech into a microphone, wherein the audio media would be fed into the emitter unit 12, transmitted out to the audience members in the coverage area, to a receiving unit 44 also in the coverage area, such that the conversion of the light radiation transmission back into audio format at a receiving unit 44 would permit at least one audience member to listen to the audio message. This system could be especially applicable to assist hearing-impaired individuals or to transmit a speaker's message in various languages. Other uses are envisioned where transmission of audio data is needed over an infrared transmission system, and particularly, when a transmission coverage area must be specifically defined or altered depending on the end user's needs.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

1. An infrared transmission and receiving system for an information stream transmission, the system comprising:
an environment;
an emitter unit mounted in an elevated position within the environment, the emitter unit having a plurality of LEDs connected to a circuit board, each of the LEDs having lead wires, each of the plurality of LEDs further having a selective angular direction for emitting infrared radiation media and at least two LEDs having different angular directions, at least one of the at least two LEDs having its pair of lead wires bent defining the LEDs angular direction; and
at least one receiver unit for receiving the infrared radiation media and translating the radiation media into discernable media.

2. The system of claim 1, wherein the environment is an indoor auditorium designed for the gathering of a plurality of people.

3. The system of claim 1, wherein the selective angular direction of the plurality of LEDs is achieved by bending a pair of bendable wire leads that connect each LED to the circuit board.

4. The system of claim 1, wherein the at least one receiver is used to translate the discernable media into audio for use by at least one of the plurality of people.

5. An emitter unit for an infrared transmission system, the emitter unit comprising:
an LED mounting board; and
an array of LEDs, each of the LEDs having
an infrared light emitting portion each light emitting portion having a selective angular direction of emission; and
a pair of bendable lead wires extending from the light emitting portion to the mounting board, at least one of the plurality of LEDs having the pair of lead wires selectively bent whereby the angular direction of emission of the light emitting portion is in an angular direction of emission different from that of at least one other of the plurality of LEDs.

6. The emitter unit of claim 5, wherein at least one of the plurality of LEDs have an angular direction of emission perpendicular to the surface of the circuit board.

7. The emitter unit of claim 5, wherein one of the plurality of LEDs is on a right side of the circuit board and the pair of lead wires of said LED is bent pointing said LED in a leftwardly direction and wherein one of the plurality of LEDs is on a left side of the circuit board and the lead wires of said LED are bent pointing said LED in a rightwardly direction.

8. The emitter unit of claim 5, wherein each pair of lead wires have an alignment direction and wherein at least two of the alignment directions of 2 LEDs are different.

9. The emitter unit of claim 5, wherein at least two of the plurality of LEDs have different angles from the vertical from one another from a perspective of directly in front of the board.

10. The emitter unit of claim 5, wherein at least 2 of the LEDs have different angles from the mounting board from one another.

11. The emitter unit of claim 5, wherein each of the pairs of bendable lead wires have an easy bend axis and where at least two of the easy bend axis are not parallel.

12. The emitter unit of claim 5, wherein the different angular directions of the plurality of LEDs is manually adjustable by an end user.

13. The emitter unit of claim 5, wherein a bending means is used for bending the wire leads to adjust the different angular directions of a selected group of the plurality of LEDS.

14. An infrared transmission and receiving system for an information stream transmission, the system comprising:
an environment;
an emitter unit mounted in an elevated position within the environment, the emitter unit having an array of LEDs connected to a circuit board, each of the LEDs having lead wires, each of the plurality of LEDs further having a selective angular direction for emitting infrared radiation media and at least two LEDs having different angular directions, at least one of the LEDs having its pair of lead wires bent defining the LEDs angular direction;
at least one receiver unit for receiving the infrared radiation media and translating the radiation media into at least one of the set of analog and digital media; and
a bending means for bending lead wires which connect the plurality of LEDs to the circuit board.

15. A method of configuring an infrared emitter unit for use in transmitting an infrared signal to a selectable transmission coverage area for receipt by an infrared receiving unit within said coverage area, comprising the steps of:
connecting a plurality of LEDs to an emitter circuit board, with each of the plurality of LEDs having a light emitting portion and at least two lead wires connecting the emitting portion and the circuit board; and
selectively bending the at least two lead wires of at least one of the plurality of LEDs such that an angular emitting direction is defined for the transmission of an infrared radiation media.

16. A method for an end user to configure an infrared emitter unit in an environment for use in transmitting an infrared signal to a selectable transmission coverage area in said environment for receipt by an infrared receiving unit within said coverage area, comprising the steps of:
observing the configuration of the environment;
selecting a desired configuration for the transmission coverage area;
gaining access to the LEDs of the emitter unit, with each of the plurality of LEDs having a light emitting portion and at least one lead wire intermediately connecting the emitting portion to a circuit board; and
selectively bending the at least one lead wire of at least one of the plurality of LEDs with bending means such that an angular emitting direction is adjusted for the transmission of an infrared radiation media whereby the desired configuration for the transmission coverage area is obtained.

17. A method for an end user to configure an infrared emitter unit in an environment for use in transmitting an infrared signal to a selectable transmission coverage area in said environment for receipt by an infrared receiving unit within said coverage area, comprising the steps of:
accessing the LEDs of the emitter unit, with each of the plurality of LEDs having a light emitting portion and a pair of lead wires intermediately connecting the emitting portion to a mounting board; and
receiving infrared signal information from an infrared signal detection unit within the environment for providing information on the infrared signal boundaries of the transmission coverage area;
selectively bending the at least one lead wire of at least one of the plurality of LEDs with bending means to adjust the size and shape of the transmission coverage area based on the information from the infrared signal detection unit.

18. The method of claim 17, further comprising the step of selecting an infrared signal detection unit for the infrared receiving unit.

19. The method of claim 17, further comprising the step of selecting an infrared signal detection unit for detecting signal direction and strength.

20. An infrared emitter unit comprising:
a housing enclosing a mounting board, the mounting board having a front face with a plurality of LEDs extending therefrom, each LED having at least two lead wires extending from the mounting board, each LED having a projection area with a central aiming axis, the projection areas of the plurality of LEDs defining a coverage area of the emitter unit, the coverage area adjustable by moving the projection areas and central aiming axis of individual LEDs by bending the at least two lead wires of the individual LEDs, at least one of the plurality of LEDs having it's lease wires bent whereby said LED has it's central aiming axis in a direction at least 10° from the central aiming axis of another of the plurality of LEDs.

21. An infrared emitter unit comprising:
a housing enclosing a mounting board, the mounting board having a front face with a plurality of LEDs extending therefrom, each LED having two lead wires extending from the mounting board, each of the two lead wires having an alignment direction, each LED having a projection area with a central aiming axis, the projection areas of the plurality of LEDs defining a coverage area of the emitter unit, the coverage area adjustable by moving the projection areas and central aiming axis at least two of the LED's drawing different alignment directions for their respective two lead wires.
